(19) United States
(12) Patent Application Publication
(10) Pub. No.: US 2015/0218045 A1
(43) Pub. Date: Aug. 6, 2015

(54) EDGE TREATING A CUT EDGE OF A GLASS PIECE

(71) Applicant: CORNING INCORPORATED, Corning, NY (US)

(72) Inventors: Robin Stuart Balcom, Corning, NY (US); Douglas Miles Noni, JR., Horseheads, NY (US); Gary Graham Squier, Elmira, NY (US); Elizabeth Marie Vileno, Corning, NY (US); Kevin Lee Wasson, Elmira, NY (US)

(21) Appl. No.: 14/423,224

(22) PCT Filed: Aug. 28, 2013
(86) PCT No.: PCT/US2013/057027

§ 371 Date: Feb. 23, 2015

Related U.S. Application Data
(60) Provisional application No. 61/695,482, filed on Aug. 31, 2012.

(51) Int. Cl. C03C 21/00; C03B 25/02; C03B 29/02; C03B 27/04

(52) U.S. Cl. CPC C03C 21/002; C03B 27/04; C03B 25/02; C03B 29/02; C03C 21/008

(57) ABSTRACT

An apparatus and method for edge treating the cut edge of a glass sheet is provided which has an a heat source and a cooling system. The glass piece has an active area and a vacant edge portion. The heat source is positioned to direct heat to the vacant edge portion and raise the temperature of the vacant edge portion of the glass piece to between 350 C and 600 C. The cooling system maintains the temperature of the active area of the glass piece below 250 C. Additionally, the cooling system includes a heat sink assembly which is thermally coupled to the active area of the glass piece.

### CROSS-REFERENCE TO RELATED APPLICATIONS

This application claims the benefit of priority under 35 U.S.C. §119 of U.S. Provisional Application Ser. No. 61/695,482 filed on Aug. 31, 2012, the entire content of which is hereby incorporated by reference.

### BACKGROUND

1. Field

The present disclosure relates generally to glass sheets and, more specifically, to an apparatus and method for chemically strengthening, tempering, flame polishing, or annealing a cut edge of a glass piece.

2. Technical Background

Chemical strengthening of glass is a surface finishing process. Glass is submersed in a bath containing a potassium salt such as potassium nitrate at a temperature in excess of 300° C. The exposure of the unstrengthened glass surface to the potassium salt causes sodium ions in the glass surface to be replaced by potassium ions from the bath solution.

The potassium ions which replace the sodium ions are larger than the sodium ions they replace. Insertion of the geometrically larger potassium ions results in the potassium ions wedging into the gaps left by the smaller sodium ions when they migrate to the potassium nitrate solution. This replacement of ions causes the surface of the glass to be in a state of compression and the core in compensating tension. The compression at the surface of chemically strengthened glass results in a lower incidence of glass breakage and cracking as a small scratch on the glass surface does not as readily propagate through the glass layer.

### SUMMARY

Chemically strengthened glass sheets are utilized in a variety of applications because of the superior mechanical properties, among other reasons. The present inventors have recognized that, upon cutting a piece of chemically strengthened glass the superior mechanical properties along the cut edge of the glass sheet are diminished as the central tension of the glass sheet is exposed. The present inventors have also recognized that the presence of circuitry and other temperature sensitive components on chemically strengthened glass sheets can make it difficult to restore mechanical properties along the cut edge of the sheet. Additionally, the present inventors have recognized that the presence of circuitry and other temperature sensitive components on a glass sheet make it difficult to apply other glass treatments which involve heating such as tempering, flame polishing, and annealing along the cut edge of the sheet. Accordingly, there is a need for processes that restore the original strength properties of the chemically strengthened glass or allow for other edge treatment processes without damaging components disposed on the glass sheet.

More specifically, post processing glass substrate edges with electronics printed on it is typically limited to low temperature (<200° C.) processes such as acid etch, grind and polish, and other chemical and mechanical techniques. This is due to the temperature sensitive dielectric layers that the electronics contain. In most products, higher temperature processing is not needed as low temperature post processing techniques achieve the desired results, and so this is not a problem. However, in some cases being able to subject these pieces to higher temperature processing would be advantageous. For example, after doing all the large sheet printing, and the cutting into smaller pieces, a manufacturer might want to fire polish, anneal, ion exchange, or otherwise heat treat the edge of a finished product without damaging the electronics contained on that glass substrate. It is desirable from the perspective of a manufacturer to print needed electronics onto the surface of a large sheet of glass and subsequently cut the large sheet into the final desired dimensions as such a procedure allows existing equipment for printing the electronics to be used and allows the circuitry for multiple units to be applied simultaneously. The apparatus and method disclosed herein allows the bulk of the glass piece to be maintained at a temperature acceptable in view of printed electronics on the glass surface while allowing the edges to be heated to high temperatures for ion exchange, fire polishing, annealing, tempering, or otherwise heat treating the edge of a finished product.

A temperature gradient is formed from the heated edge of the glass piece to the cooled bulk of the glass piece. The distance from the edge of the glass to the point where the temperature drops to below that of damaging the electronics layer is termed the “burn back”. This is typically about 0.5 to about 2 mm, with the shorter distance being more desirable but more difficult to achieve. A shorter distance is desirable because it allows electronics to be placed closer to the edge of the glass sheet and for applications such as a fully integrated touch screen maximizing the active surface area of the screen is desirable.

The present disclosure introduces apparatuses and methods for edge treating a cut edge of a glass piece.

In accordance with particular embodiments of the present disclosure, apparatuses for chemically strengthening a cut edge of a chemically strengthened glass sheet are provided comprising an ion exchange source, a heat source and a cooling system. The chemically strengthened glass piece has an active area and a vacant edge portion. The heat source is positioned to direct heat to the ion exchange source and raise the temperature of the vacant edge portion of the chemically strengthened glass piece to between 350° C. and 600° C. The cooling system maintains the temperature of the active area of the chemically strengthened glass piece below 250° C. The cooling system includes a heat sink assembly which is thermally coupled to the active area of the chemically strengthened glass piece. Additionally the vacant edge portion of the chemically strengthened glass piece is exposed beyond the extent of the heat sink assembly.

In accordance with particular embodiments of the present disclosure, apparatuses for chemically strengthening a cut edge of a chemically strengthened glass sheet are provided comprising an ion exchange source, a heat source and a cooling system. The chemically strengthened glass piece has an active area and a vacant edge portion. The heat source is positioned to direct heat to the ion exchange source and raise the temperature of the vacant edge portion of the chemically strengthened glass piece to between 350° C. and 600° C. The cooling system maintains the temperature of the active area of the chemically strengthened glass piece below 250° C. The cooling system includes a heat sink assembly which is thermally coupled to the active area of the chemically strengthened glass. Additionally the vacant edge portion of the chemically strengthened glass is exposed beyond the extent of the heat sink assembly. The heat sink assembly includes spacers, gaskets, and clamping members. A repeating series of pieces of chemically strengthened glass and spacers with gaskets affixed thereto are pressed together between the clamping members forming fluid tight seals between the gaskets and pieces of chemically strengthened glass. The gaskets are disposed on a first side of the spacers and a second side of the spacers. The gaskets specifically include a body gasket and an edge gasket on each of the first side of the spacers and the second side of the spacers. The body gaskets and the edge gaskets are disposed on the first side of the spacers and the second side of the spacers with a fluid flow channel having an inlet end and an outlet end formed between the body gasket and the edge gasket on both the first and second side of the spacers. The cooling system also includes a heat transfer fluid. The chemically strengthened glass and the heat sink assembly are thermally immersed in the heat transfer fluid. Additionally, the ion exchange source is a paste comprising at least one salt and at least one binder capable of being spread on the vacant edge portion of the chemically strengthened glass and heated to greater than the melting point of the at least one salt without running off of the cut edge.

In accordance with particular embodiments of the present disclosure, apparatuses for edge treating a cut edge of a at least one glass piece are provided comprising a heat source and a cooling system. The apparatus is configured to anneal, temper, flame polish, or chemically strengthen the cut edge of the at least one glass piece. The at least one glass piece has an active area and a vacant edge portion. Additionally, the heat source is positioned to direct heat to the vacant edge portion of the glass piece and raises the temperature of the vacant edge portion of the glass piece to between 350° C. and 600° C. The cooling system has a heat sink assembly which is thermally coupled to the active area and maintains the temperature of the active area below 250° C. The vacant edge portion is exposed beyond the extent of the heat sink assembly.

In accordance with particular embodiments of the present disclosure, methods for treating a cut edge of at least one glass piece are provided. The method includes providing at least one glass piece comprising an active area and a vacant edge portion. The method further includes providing an apparatus for edge treating the cut edge of the at least one glass piece. The apparatus comprises a heat source and a cooling system. The heat source is positioned to direct heat to the vacant edge portion of the glass piece and raises the temperature of the vacant edge portion of the glass piece to between 350° C. and 600° C. The cooling system has a heat sink assembly which is thermally coupled to the active area and maintains the temperature of the active area below 250° C. Additionally, the vacant edge portion is exposed beyond the extent of the heat sink assembly. The method also includes annealing, tempering, flame polishing, or chemically strengthening the cut edge of the at least one glass piece.

Additional features and advantages of the invention will be set forth in the detailed description which follows, and in part will be readily apparent to those skilled in the art from that description or recognized by practicing the various embodiments described herein, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic illustration of an apparatus for edge treating a cut edge of a glass piece according to one embodiment of the present disclosure;

FIG. 2 is a partial cut end view of an apparatus for edge treating a cut edge of a glass piece according to one embodiment of the present disclosure;

FIG. 3 is a cut front view of an apparatus for edge treating a cut edge of a glass piece according to one embodiment of the present disclosure;

FIG. 4 is a cut front view of an apparatus for edge treating a cut edge of a glass piece according to one embodiment of the present disclosure;

FIG. 5 is a partial cut end view of a of an apparatus for edge treating a cut edge of a glass piece according to one embodiment of the present disclosure; and

FIG. 6 is a schematic illustration of an apparatus for edge treating a cut edge of a glass piece according to one embodiment of the present disclosure.

Referring to the drawings in general, it will be understood that the illustrations are for the purpose of describing a particular embodiment of the invention and are not intended to limit the invention thereto.

### DETAILED DESCRIPTION

A variety of edge treatments are envisioned compatible with embodiments of the apparatus 100. Chemical strengthening the cut edge of the glass piece 140 is one specific edge treatment envisioned. Other edge treatments include tempering, flame polishing, or annealing the cut edge of the glass piece 140. In the interest of clarity, discussion throughout this disclosure is primarily directed toward chemically strengthening the glass piece 140, but one skilled in the art would realize that tempering, flame polishing, annealing, or another edge treatment could be substituted.

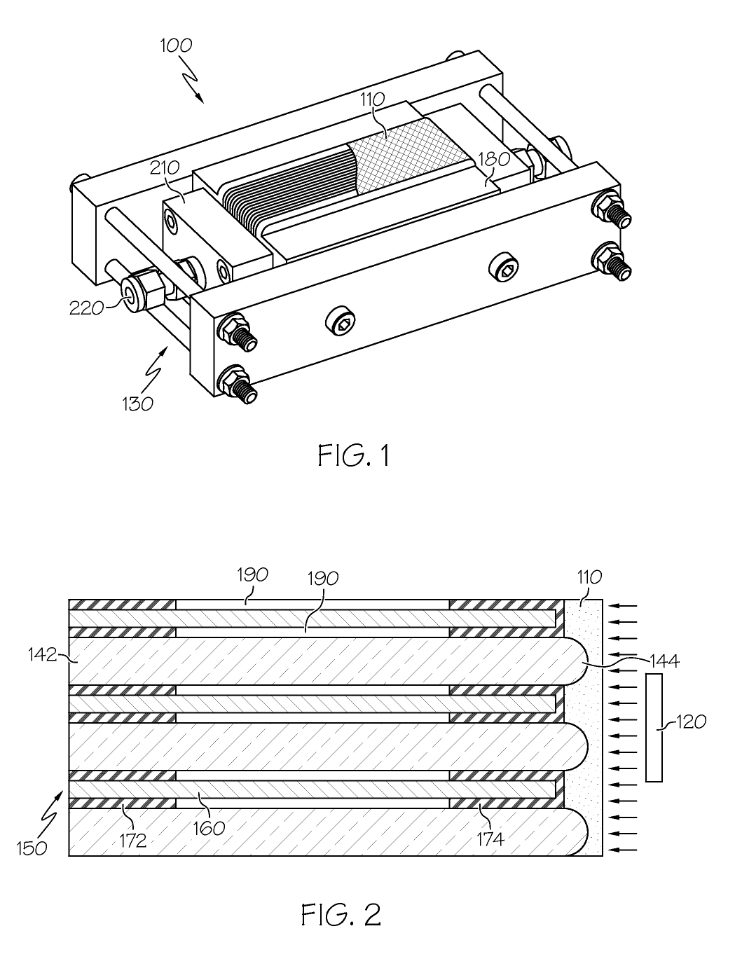

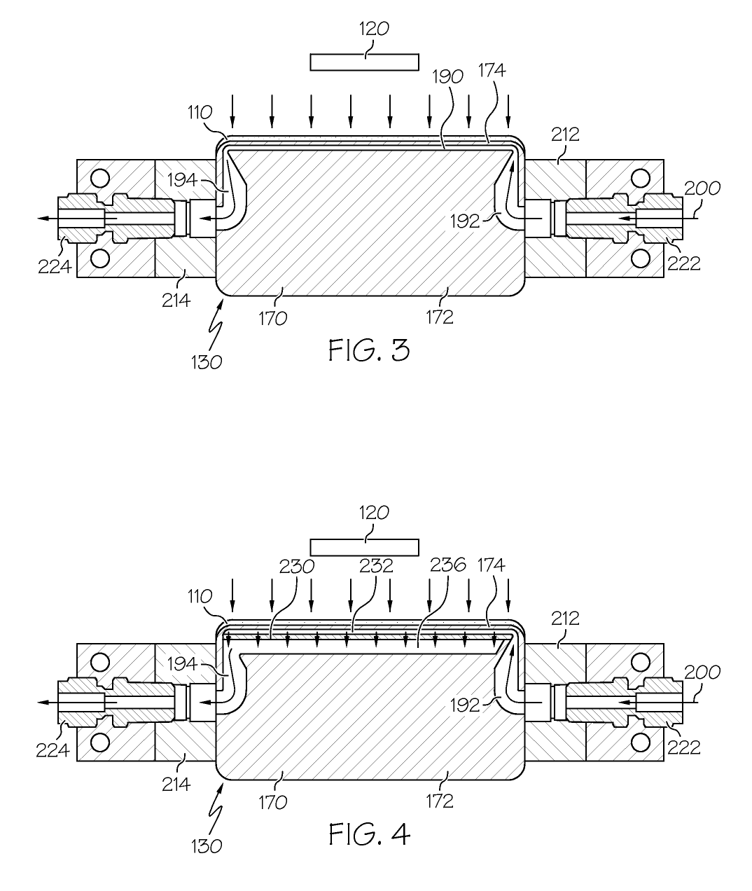

An embodiment of an apparatus 100 for chemically strengthening a cut edge of a glass piece 140 is shown in FIGS. 1, 2 and 3. The apparatus 100 comprises an ion exchange source 110, a heat source 120 and a cooling system 130. The glass piece 140 comprises both an active area 142 and a vacant edge portion 144. The active area 142 of the glass piece 140 is the region where electronic circuitry or other heat sensitive surface treatments are disposed on the chemically strengthened glass piece. The vacant edge portion 144 is the region of the glass piece 140 along the cut edge. The vacant edge portion 144 is preferably substantially bare glass, but may comprise a nominal amount of contaminants or non-heat sensitive applications.

The glass pieces 140 may include any glass substrate. Non-limiting examples of specific glass pieces 140 include previously chemically strengthened glass, non-chemically strengthened glass, and laminates.

The heat source 120 is positioned to direct heat to the vacant edge portion 144 of the glass piece 140. It is also envisioned that when the edge treatment is chemical strengthening of the glass piece 140 the heat source 120 is directed specifically to the ion exchange source 110. The heat source 120 is configured and sized to preferably raise the temperature of the vacant edge portion 144 of the glass piece 140 to between approximately 350° C. and approximately 600° C., more preferably to between approximately 400° C. and approximately 550° C., and even more preferably to between approximately 420° C. and approximately 480° C. In further embodiments it is specifically envisioned that the heat source 120 is configured and sized to raise the temperature of the vacant edge portion 144 to each range bounded by integer values encompassed by the range of 350° C. to 600° C.

The cooling system 130 comprises a heat sink assembly 150 thermally coupled to the active area 142. The cooling system 130 and heat sink assembly 150 are preferably configured and sized to maintain the temperature of the active area 142 below approximately 250° C., more preferably below approximately 200° C., and even more preferably below approximately 180° C. In further embodiments it is specifically envisioned that the cooling system 130 and heat sink assembly 150 are configured and sized to maintain the temperature of the active area 142 at or below each integer value between 0° C. and 250° C.

The vacant edge portion 144 is exposed beyond the extent of the heat sink assembly 150. As the vacant edge portion 144 is heated as part of the ion exchange process, the vacant edge portion preferably extends beyond the heat sink assembly 150. Extension of the vacant edge portion 144 beyond the heat sink assembly 150 allows the extended portion of the vacant edge portion to have a temperature equal to or in excess of 350° C. or the desired temperature without counteracting cooling by the heat sink assembly.

In a selected embodiment of the apparatus 100 for chemically strengthening a cut edge of a glass piece 140 the apparatus also comprises spacers 160, gaskets 170 and clamping members 180. The gaskets 170 are disposed on the front and back, also termed first and second sides, of the spacers 160. The spacers 160 with gaskets 170 affixed thereto are arranged in a repeating series of glass pieces 140 and the spacer/gasket combination. The repeating series of glass pieces 140 and spacers 160 with gaskets 170 affixed thereto are pressed together between the clamping members 180 to form fluid tight seals between the gaskets and glass pieces.

The clamping members 180 apply a force to opposing faces of the repeating series of glass pieces 140 and spacers 160 with gaskets 170 affixed thereto. As the clamping members are exposed to the ion exchange source 110 and the heat from the heat source 120, the clamping members are preferably stainless steel, but are envisioned to also be made of known materials resistant to heat and damage from the ion exchange source.

In a selected embodiment, the spacers 160 are envisioned as comprising thermally conductive metal such as, for example, aluminum or copper. Additionally, the gaskets 170 are envisioned in an embodiment of the apparatus 100 as comprising silicone or polytetraflouroethylene. It is also envisioned that in selected embodiments of the apparatus 100 the gaskets 170 comprise a release coating to ease sticking to the chemically strengthened glass 140 and/or the chemically strengthened glass comprises a removable release agent to ease sticking of the gaskets. The release coating or agent can be boron nitride, Teflon, silicone, graphite, among others. The choice would be dependent on the compatibility with the gasket material and any paste applied to the edge of the glass. For example, graphite could be used where the paste is not oxidizing or when paste is not used (i.e., for tempering application, for example) and the atmosphere is controlled to exclude oxygen.

According to one embodiment of the method, the gasket surface was prepared with a boron nitride powder release agent (ordered from McMaster Carr, made by Momentive Performance Materials-Quartz, Inc from Strongsville Ohio, called Boron Nitride Spray II, a high temperature release coating) by rubbing the powder into the surface of the gasket until the surface was smoothed. The spacer and gasket piece was then blown with a small amount of gas to remove loose powder. Upon reuse of the gasket and spacer piece, the boron nitride powder was reapplied if sticking to the glass was noticed. If too much was used or if it was not uniformly applied then pathways through the gasket are allowed and a good seal is not maintained. If too little is used, the gasket sticks to the glass.

In a selected embodiment of the apparatus 100 for chemically strengthening a cut edge of a glass piece 140, the repeating series glass pieces and spacers 160 with gaskets 170 affixed thereto comprises alternating glass pieces and spacers with gaskets (i.e. glass-gasket/spacer/gasket-glass-gasket/spacer/gasket-glass). In another selected embodiment of the apparatus 100 for chemically strengthening a cut edge of a glass piece 140 the repeating series of glass pieces and spacers 160 with gaskets 170 affixed thereto comprises groupings of two glass pieces separated by spacers with gaskets (i.e. gasket/spacer/gasket-glass-glass-gasket/spacer/gasket-glass-glass-gasket/spacer/gasket). It is envisioned that the repeating series of pieces of glass pieces 140 and spacers 160 with gaskets 170 affixed thereto may comprise every integer value from a single piece of glass to hundreds of pieces of glass, including, for example, ten pieces of glass, fifty pieces of glass, and two hundred pieces of glass.

In a further selected embodiment of the apparatus 100 for chemically strengthening a cut edge of a glass piece 140 the gaskets 170 comprise a body gasket 172 and an edge gasket 174. The body gasket 172 and the edge gasket 174 are each disposed on both the first side and the second side of the spacer 160. The body gasket 172 and the edge gasket 174 form a fluid flow channel 190 in combination with the glass piece 140 and the spacer 160. The fluid flow channel 190 has an inlet end 192 and an outlet end 194. Further, according to an embodiment, the cooling system 130 further comprises a heat transfer fluid 200. The chemically strengthened glass 140 and the heat sink assembly 150 are thermally immersed in the heat transfer fluid 200. For example, the heat transfer fluid 200 may be passed through the fluid flow channel 190 from the inlet end 192, past the chemically strengthened glass 140 and out the outlet end 194.

In a further selected embodiment of the apparatus 100 for chemically strengthening a cut edge of a glass piece 140, the heat sink assembly 150 further comprises headers 210. The headers 210 comprise an inlet header 212 and an outlet header 214. The inlet header 212 is disposed in fluid communication with the inlet end 192 of the fluid flow channels 190 and the outlet header 214 is disposed in fluid communication with the outlet end 194 of the fluid flow channels. The headers 210 are configured to allow distribution of the heat transfer fluid 200 across a plurality of fluid flow channels 190 to cool a plurality of glass pieces 140 simultaneously. Specifically, the inlet header 212 accepts a feed stream of heat transfer fluid 200 and interfaces with one or more fluid flow channels 190 to pass the heat transfer fluid through the fluid flow channels. After passing through the fluid flow channels 190, the heat transfer fluid 200 is consolidated back into an exit stream via the outlet header 214. The headers 210 are preferably stainless steel but are envisioned to also be made of known materials resistant to heat and damage from the ion exchange source 110. The apparatus 100 preferably includes a single inlet header 212 and a single outlet header 214, but it is envisioned that multiple inlet headers or outlet headers could interface with the fluid flow channels 190. Additionally, it is envisioned that one or multiple feed streams may provide the heat transfer fluid 200 to one or multiple inlet headers 212.

In a further selected embodiment of the apparatus 100 for chemically strengthening a cut edge of a glass piece 140, the heat sink assembly 150 further comprises fluid fittings 220. An inlet fluid fitting 222 is in fluid communication with the inlet header 212 and the outlet fluid fitting 224 is in fluid communication with the outlet header 214. The fluid fittings can be any type of fluid tight connection known in the art with non-limiting examples including a threaded connector, a quick-release style connector, or a compression fitting.

The heat transfer fluid 200 may comprise a liquid or a gas. Non-limiting examples of a liquid heat transfer fluid 200 include water, ethylene glycol, propylene glycol, and oils. Non-limiting examples of a gas heat transfer fluid 200 include air, nitrogen, and helium. The heat capacity between different heat transfer fluids 200 varies and as a result the ability for the heat transfer fluid to adequately remove heat along the entire length of the fluid flow channel 190 must be considered. If the heat capacity of the heat transfer fluid 200 is too low it will absorb heat at the inlet end 192 of the fluid flow channel 190 but will no longer have the ability to absorb additional heat prior to reaching the outlet end 194.

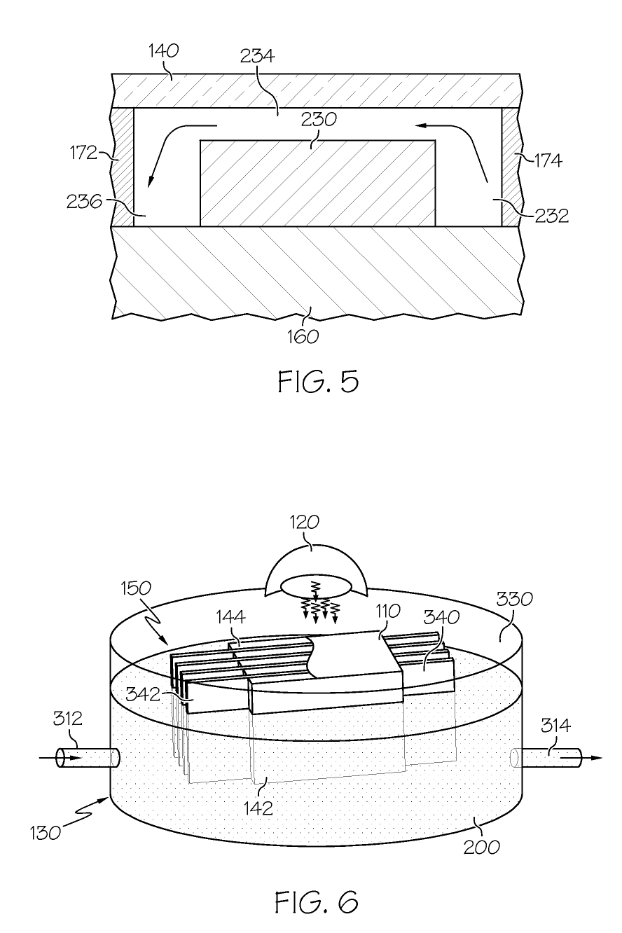

Referring to FIGS. 4 and 5, in an embodiment of the apparatus 100 for chemically strengthening a cut edge of a glass piece 140, the heat sink assembly 150 further comprises a fluid flow restrictor 230. The fluid flow restrictor 230 is disposed in the fluid flow channel 190 to form a long inlet region 232, a tight fluid gap 234 between the fluid flow restrictor and the chemically strengthened glass 140, and a long exit region 236.

The heat transfer fluid 200 enters the inlet end 192 of the fluid flow channel 190 as with the other disclosed embodiments. The fluid flow restrictor 230 restricts the heat transfer fluid 200 from passing between the fluid flow restrictor and the glass piece 140. The restriction as a result of the fluid flow restrictor 230 forces the heat transfer fluid 200 entering the fluid flow channel 190 to distribute along the length of the long inlet region 232. The heat transfer fluid 200 then passes between the fluid flow restrictor 230 and the glass piece 140, through the tight fluid gap 234, and enters the long exit region 236 to pass out of the fluid flow channel 190. The tight fluid gap 234 formed between the fluid flow restrictor 230 and the glass piece 140 is very small compared to the size of the fluid flow channel 190 so that the flow is uniformly distributed with equal velocity along the entire length of the tight fluid gap.

Referring to FIG. 6, in an embodiment of the apparatus 100 for chemically strengthening a cut edge of a glass piece 140, the heat sink assembly 150 comprises at least two flow ports 310, at least one heat conductor 340, and a fluid reservoir 330. The flow ports 310 comprise an inlet flow port 312 and an outlet flow port 314. The inlet flow port 312 and the outlet flow port 314 are in fluid communication with the fluid reservoir 330. Additionally, a repeating series of pieces of glass pieces 140 and heat conductors 340 are disposed in the fluid reservoir. Further, according to an embodiment, the cooling system 130 further comprises a heat transfer fluid 200. The glass pieces 140 and the heat sink assembly 150 are thermally immersed in the heat transfer fluid 200. For example, the heat transfer fluid 200 may be passed through the inlet flow port 312 and into the fluid reservoir 330 to surround and thermally immerse the glass pieces 140 and the heat sink assembly 150 disposed therein and finally pass out of the fluid reservoir through the outlet flow port 314.

In a selected embodiment of the apparatus 100 for chemically strengthening a cut edge of a glass piece 140, the repeating series of glass pieces 140 and heat conductors 340 comprises alternating glass pieces and heat conductors (i.e. glass-heat conductor-glass-heat conductor-glass). In another selected embodiment of the apparatus 100 for chemically strengthening a cut edge of a glass piece 140, the repeating series of glass pieces and heat conductors 340 comprises groupings of two glass pieces separated by heat conductors (i.e. heat conductor-glass-glass-heat conductor-glass-glass-heat conductor). It is envisioned that the repeating series of glass pieces and heat conductors 340 may comprise every integer value from a single piece of glass to hundreds of pieces of glass, including, for example, ten pieces of glass, fifty pieces of glass, and two hundred pieces of glass.

In an embodiment of the apparatus 100 for chemically strengthening a cut edge of a glass piece 140, the heat conductor 340 is wider than the glass pieces such that it extends beyond the glass pieces to form radiator fins 342. In another embodiment of the apparatus 100 for edge treating a cut edge of a glass piece 140, the heat conductor 340 is substantially the same width as the glass piece. Substantially the same width is meant to mean that the glass piece 140 and the heat conductor 340 differ in length by less than 10%, less than 8%, less than 6%, less than 4%, less than 2%, or less than 1%.

In an embodiment of the apparatus 100 for chemically strengthening a cut edge of a glass piece 140, the active area 142 comprises a printed circuit. Printed circuits are utilized in various applications on the surface of glass sheets. For example, a fully integrated touch screen detects the presence and location of a touch by the user within the display area through the use of printed circuits on the glass screen's surface.

In an embodiment of the apparatus 100 for chemically strengthening a cut edge of a glass piece 140, the ion exchange source is a paste applied to the cut edges of the glass piece. The ion exchange paste comprises at least one salt and at least one binder. The paste is also capable of being spread on the vacant edge portion 144 of the glass piece 140 and heated to greater than the melting point of the at least one salt without the ion exchange paste running off the cut edge. The ion exchange paste needs to be able to withstand heating to above the melting point of the at least one salt without running off the cut edge because the salt must be in a melted state to undergo the ion exchange process. For example, a method of chemically strengthening glass includes the exchange of sodium ions in the cut glass for potassium ions from a salt and the potassium salt must be in a melted state to properly exchange the ions. The at least one salt is preferably a potassium salt. Specific, non-limiting, examples of potassium salts include KNO₃, KNO₂, KCl, K₂SO₄, or a combination thereof. Additionally, the at least one binder is preferably clay, aluminum oxide, iron oxide, zeolites, other inert organic materials, or a combination thereof.

In another embodiment of the apparatus 100 for chemically strengthening a cut edge of a glass piece 140, the ion exchange source 110 is a bath of pure molten salt. The at least one salt is preferably a potassium salt. Specific, non-limiting, examples of potassium salts include KNO₃, KNO₂, KCl, K₂SO₄, or a combination thereof. The exchange of ions as part of the chemical strengthening process is achieved by submersing at least the cut edge of the chemically strengthened glass piece 140 into a bath of molten salt. The molten salt is in fluid contact with the cut edge and exchange of ions, for example sodium and potassium, in the glass piece 140 is achieved in the same manner as when an ion exchange paste is utilized. It is further envisioned that the apparatus 100 may be partially or fully submerged within the molten salt bath with the cooling system 130 maintaining the temperature of the active area 142 of the glass piece 140 below the desired threshold temperature.

In an embodiment of the apparatus 100 for chemically strengthening a cut edge of a glass piece 140, the heat source 120 is an infrared (IR) source. In another embodiment of the apparatus 100 for chemically strengthening a cut edge of a glass piece 140, the heat source 120 is a resistive heater. Additional embodiments and envisioned heat sources also include induction heating, convection and conductive heating, microwave or radio frequency (RF) heating. In the embodiment wherein the ion exchange source is a bath of pure molten salt, the heat source may be the salt bath itself.

Once again, while the disclosure of the apparatus 100 is primarily directed toward cooling the glass pieces 140 while ion exchanging the edge of the glass to establish or reestablish compressive strength, the apparatus and teachings could be extended to other high temperature processing such as fire polishing, annealing, or tempering. The same principles and systems which maintain the temperature of the active area 142 of the glass pieces 140 in an acceptable range during strengthening a cut edge are applicable when cooling the active area during a fire polishing or annealing process.

Numerous embodiments of the apparatus 100 for edge treating the cut edge of a glass piece 140 are disclosed herein. It should be understood that elements taught and disclosed in one embodiment are applicable to the other disclosed embodiments. All combinations of disclosed elements are envisioned in combination with each disclosed embodiment.

Empirical testing was undertaken to verify the effectiveness of the apparatus 100. The apparatus 100, as depicted in FIG. 1, was utilized to test the cooling effectiveness. A 30 kW IR source lamp with a light flux of approximately 1,000,000 W/m² max flux was suspended 6 inches above the apparatus 100. Eight spacers 160 and seven pieces of 49 mm×100 mm cut glass piece 140 were mounted into the assembly. The glass pieces 140 were previously chemical strengthened prior to cutting to size. A 1 mm thick layer of clay and potassium nitrite paste (ion exchange paste) as the ion exchange source 110 was coated onto the surface of the glass pieces 140 and spacers 160. The lamp source was powered to 65% (600,000 W/m²) flux. The surface of the ion exchange paste reached a temperature of 530 to 550° C. within 30 seconds and was maintained at 500° C. (as measured by a FLIR IR camera with an emissivity of 0.94) for the duration of the experiment by adjusting the power of the IR system as necessary. The lamp was fully powered down after two hours and the glass pieces 140 were removed from the apparatus 100. The ion exchange depth at the cut edge as measured by back scattering and microprobe was shown to be 30 μm. The strength of the glass was also shown to improve from 148 MPa to 468 MPa average. Additionally, the strength was mostly retained (over 80%) subsequent to abrasion with SiC. Finally, the effectiveness of the cooling system 130 and the apparatus 100 was verified as the glass pieces 140 with an organic layer printed thereon (benzocyclobutene—“BCB”) showed that the layer survived with a burn back distance of up to 1 mm from the edge with no damage seen with an optical image.

As used herein, the singular forms “a,” “an” and “the” include plural referents. Recitations herein of “at least one” component, element, etc., should not be used to create an inference that the alternative use of the articles “a” or “an” should be limited to a single component, element, etc.

For the purposes of describing and defining the present invention it is noted that the terms “substantially,” “approximately,” and “about” are utilized herein to represent the inherent degree of uncertainty that may be attributed to any quantitative comparison, value, measurement, or other representation. The terms “substantially,” “approximately,” and “about” are also utilized herein to represent the degree by which a quantitative representation may vary from a stated reference without resulting in a change in the basic function of the subject matter at issue.

It is also noted that recitations herein of a component of the present disclosure being “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An apparatus for chemically strengthening a cut edge of at least one chemically strengthened glass piece, the apparatus comprising an ion exchange source, a heat source and a cooling system; wherein,
the chemically strengthened glass piece comprises an active area and a vacant edge portion;
the heat source is positioned to direct heat to the ion exchange source and raises the temperature of the vacant edge portion of the chemically strengthened glass piece to between 350° C. and 600° C.;
the cooling system comprises a heat sink assembly thermally coupled to the active area and maintains the temperature of the active area below 250° C.; and
the vacant edge portion is exposed beyond the extent of the heat sink assembly.

2. The apparatus of claim 1, wherein:
the heat sink assembly comprises at least one spacer, gaskets, and clamping members;
the gaskets are disposed on a first side of the spacer and a second side of the spacer; and
a repeating series of pieces of chemically strengthened glass and spacers with gaskets affixed thereto are pressed together between the clamping members to form fluid tight seals between the gaskets and pieces of chemically strengthened glass.

3. The apparatus of claim 2, wherein:
the gaskets comprise a body gasket and an edge gasket on each of the first side of the spacer and the second side of the spacer;
the body gasket and the edge gasket are disposed on the first side of the spacer and the second side of the spacer with fluid flow channels having an inlet end and an outlet end formed between the body gasket and the edge gasket on both the first and second side of the spacer;
the cooling system further comprises a heat transfer fluid; and
the chemically strengthened glass and the heat sink assembly are thermally immersed in the heat transfer fluid.

4. The apparatus of claim 3, wherein:
the heat sink assembly further comprises headers;
the headers comprise an inlet header and an outlet header; and
the inlet end of the fluid flow channels are in fluid communication with the inlet header and the outlet end of the fluid flow channels are in fluid communication with the outlet header.

5. The apparatus of claim 4, wherein:
the heat sink assembly further comprises fluid fittings;
the fluid fittings comprising an inlet fluid fitting and an outlet fluid fitting; and
the inlet fluid fitting is in fluid communication with the inlet header and the outlet fluid fitting is in fluid communication with the outlet header.

6. The apparatus of claim 2, wherein the repeating series of pieces of chemically strengthened glass and spacers with gaskets affixed thereto comprises alternating pieces of chemically strengthened glass and spacers with the gaskets.

7. The apparatus of claim 2 wherein:
the gaskets comprise a body gasket and an edge gasket;
the body gasket and the edge gasket are disposed on the first side of the spacer and the second side of the spacer with a fluid flow channel having an inlet end and an outlet end formed between the body gasket and the edge gasket on both the first and second side of the spacer;
the heat sink assembly further comprises a fluid flow restrictor;
the fluid flow restrictor disposed in the fluid flow channel to form a long inlet region, a tight fluid gap between the fluid flow restrictor and the chemically strengthened glass, and a long exit region;
the cooling system further comprises a heat transfer fluid; and
the chemically strengthened glass and the heat sink assembly are thermally immersed in the heat transfer fluid.

8. The apparatus of claim 7, wherein the heat transfer fluid is a gas.

9. The apparatus of claim 2, wherein a surface of at least one of the gaskets has a release agent disposed thereon.

10. The apparatus of claim 1, wherein:
the heat sink assembly comprises at least two flow ports, at least one heat conductor, and a fluid reservoir;
the flow ports comprise an inlet flow port and an outlet flow port;
the inlet flow port is in fluid communication with the fluid reservoir;
the outlet flow port is in fluid communication with the fluid reservoir;
a repeating series of pieces of chemically strengthened glass and the heat conductors are disposed in the fluid reservoir;
the cooling system further comprises a heat transfer fluid; and
the chemically strengthened glass piece and the heat sink assembly are thermally immersed in the heat transfer fluid.

11. The apparatus of claim 10, wherein the heat conductor is wider than the chemically strengthened glass piece such that it extends beyond the chemically strengthened glass piece to form radiator fins.

12. The apparatus of claim 11, wherein the heat conductor is substantially the same width as the chemically strengthened glass piece.

13. The apparatus of claim 11, wherein the repeating series of pieces of chemically strengthened glass and the heat conductors is alternating pieces of chemically strengthened glass and heat conductors.

14. The apparatus of claim 1, wherein the active area of the chemically strengthened glass piece comprises printed circuits.

15. The apparatus of claim 1, wherein the ion exchange source is a paste comprising at least one salt and at least one binder capable of being spread on the vacant edge portion of the chemically strengthened glass piece and heated to greater than the melting point of the at least one salt without running off of the cut edge of the chemically strengthened glass piece.

16. The apparatus of claim 1, wherein the ion exchange source is a bath of pure molten salt.

17. The apparatus of claim 1, wherein the heat source is an IR source.

18. The apparatus of claim 1, wherein the heat source is positioned to direct heat to the ion exchange source and raises the temperature of the vacant edge portion of the chemically strengthened glass piece to between 420° C. and 480° C. and the cooling system comprises a heat sink assembly thermally coupled to the active area and maintains the temperature of the active area below 180° C.

19. An apparatus for edge treating a cut edge of at least one glass piece, the apparatus comprising a heat source and a cooling system; wherein,
the glass piece comprises an active area and a vacant edge portion;
the heat source is positioned to direct heat to the vacant edge portion of the glass piece and raises the temperature of the vacant edge portion of the glass piece to between 350° C. and 600° C.;
the cooling system comprises a heat sink assembly thermally coupled to the active area and maintains the temperature of the active area below 250° C.;
the vacant edge portion is exposed beyond the extent of the heat sink assembly; and
the apparatus is configured to anneal, temper, flame polish, or chemically strengthen the cut edge of the at least one glass piece.

20. A method for treating a cut edge of at least one glass piece, the method comprising:
providing at least one glass piece comprising an active area and a vacant edge portion;
providing an apparatus for edge treating the cut edge of the at least one glass piece, the apparatus comprising a heat source and a cooling system; wherein, the heat source is positioned to direct heat to the vacant edge portion of the glass piece and raises the temperature of the vacant edge portion of the glass piece to between 350° C. and 600° C., the cooling system comprises a heat sink assembly thermally coupled to the active area and maintains the temperature of the active area below 250° C., and the vacant edge portion is exposed beyond the extent of the heat sink assembly; and
annealing, tempering, flame polishing, or chemically strengthening the cut edge of the at least one glass piece.

21. The method of claim 20, wherein:
the method further comprises supplying an ion exchange source and chemically strengthening the cut edge of the at least one glass piece.
